(19) United States
(12) Patent Application Publication
(10) Pub. No.: US 2007/0050524 A1
(43) Pub. Date: Mar. 1, 2007

(54) Configurable notification generation

(75) Inventors: Julien F. Carreno, Ennis (IE); Pierre Laurent, Quin (IE)

Correspondence Address: CAVEN & AGHEVLI;c/o INTELLEVATE, P.O. BOX 52050, MINNEAPOLIS, MN, 55402, US

(73) Assignee: Intel Corporation

(21) Appl. No.: 11/212,178

(22) Filed: Aug. 26, 2005

(51) Int. Cl. G06F 3/00

(52) U.S. Cl. 710/17

(57) ABSTRACT

Techniques that may be utilized in various computing environments are described. In one embodiment, an output event is generated based on a portion of a coalescing flag.

### BACKGROUND

When designing a communication system between a processor and a network interface, a designer generally considers the amount of traffic that will be passing through the system. The amount of traffic may be one of the major determining factors in deciding which notification method to use for passing data between the interface and the processor.

At low traffic rates, an event-driven mechanism may be utilized. With an event-driven mechanism, the network interface notifies the processor through an interrupt regarding any traffic on the network interface. Such interruptions allow for low latency and no processor usage in the absence of traffic. The higher the traffic rate, however, the more interrupts are generated which may lead to difficulties, e.g., when an operation system executing on the processor is unable to handle all the interruptions, for example, because of the excessive number of interrupts.

When dealing with high traffic rates, a queuing and polling mechanism may be utilized. In such a scheme, the processor may continuously poll the network interface in order to detect traffic. This generates some processor resource overhead, even in the absence of traffic. Also, latency may be increased due to time lapses between polling operations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 2 illustrate block diagrams of portions of multiprocessor systems, in accordance with various embodiments.

FIGS. 3A and 3B illustrate flow diagrams of embodiments of methods which may provide configurable notification generation.

FIG. 4 illustrates an embodiment of a distributed processing platform.

FIGS. 5 and 6 illustrate block diagrams of computing systems in accordance with various embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

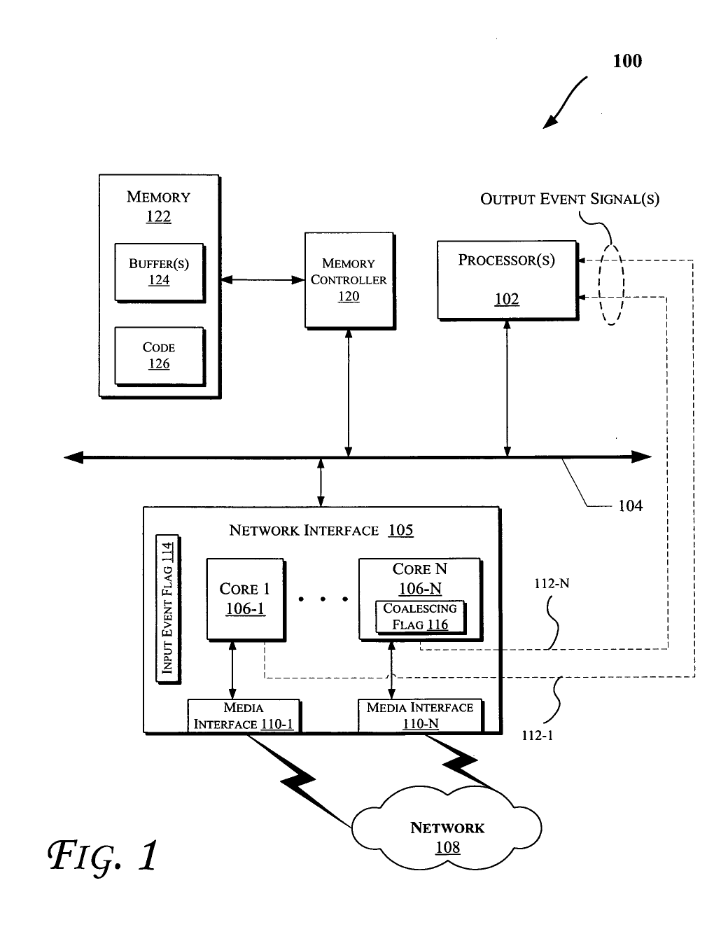

Techniques discussed herein with respect to various embodiments may provide configurable notification generation in various computing environments (e.g., multithreaded environments), such as those executing on systems discussed with reference to FIGS. 1, 2, 5, and 6. More particularly, FIG. 1 illustrates a block diagram of portions of a multiprocessor system 100, in accordance with an embodiment of the invention. The system 100 includes one or more processor(s) 102. The processor(s) 102 may be coupled through a bus (or interconnection network) 104 to other components of the system 100, such as the network interface 105. As shown in FIG. 1, the network interface 105 may include one or more processor cores (106-1 through 106-N).

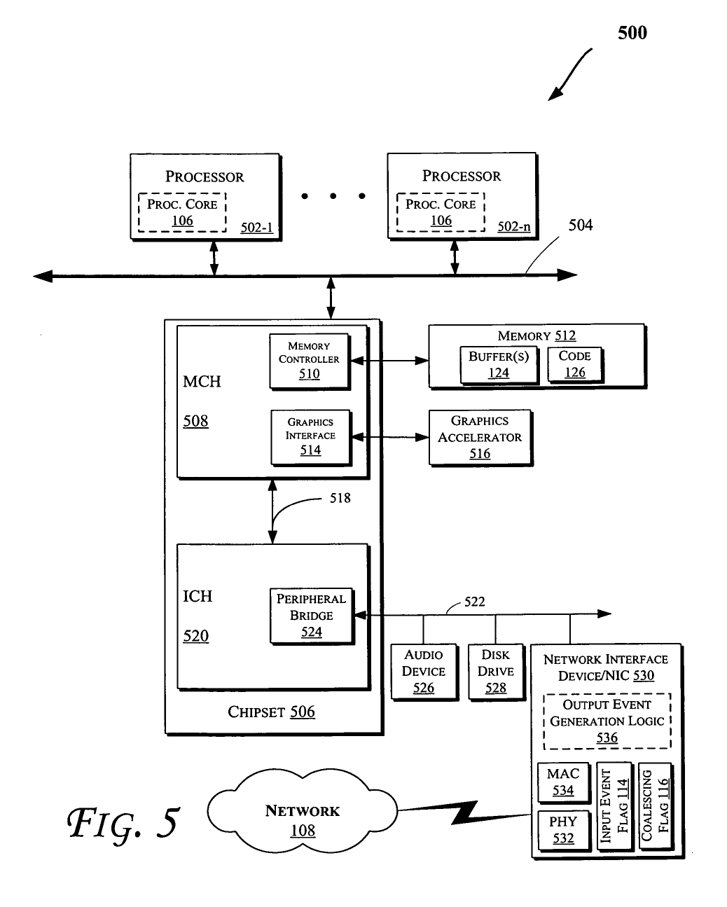

Any suitable processor such as those discussed with reference to FIGS. 5 and/or 6 may comprise the processor cores (106) and/or the processor(s) 102. Also, the processor cores 106 and/or the processor(s) 102 may be provided on the same integrated circuit die. In one embodiment, the system 100 may process data communicated through a computer network (108). In an embodiment, the processor cores (106) may be, for example, one or more microengines (MEs) and/or network processor engines (NPEs). Additionally, the processor(s) 102 may be a core processor (e.g., to perform various general tasks within the system 100). In an embodiment, the processor cores 106 may provide hardware acceleration related to tasks such as data encryption or the like.

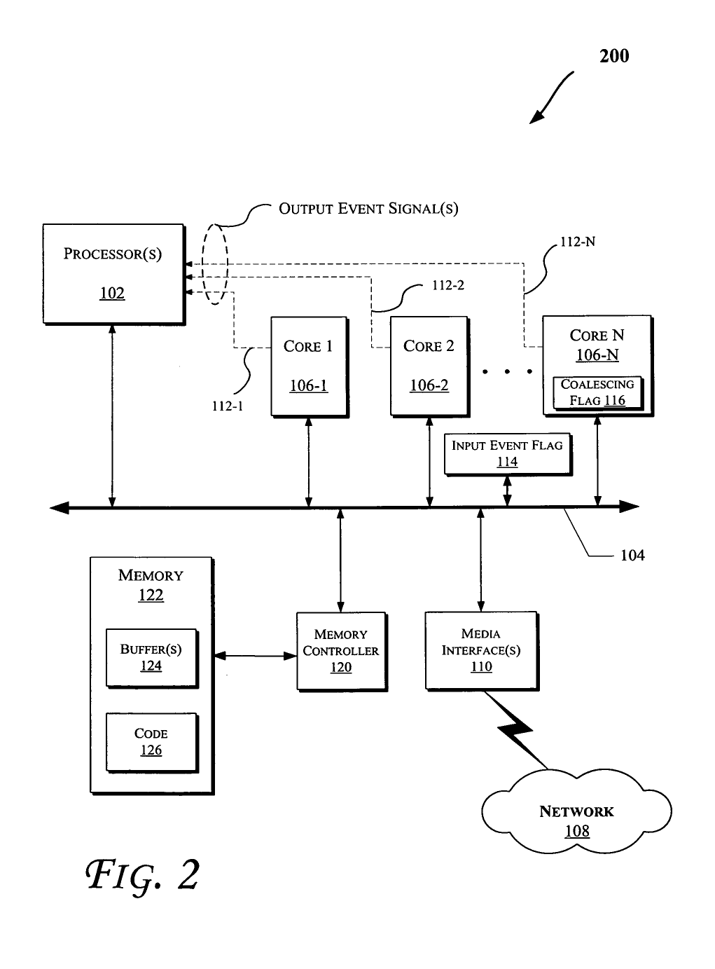

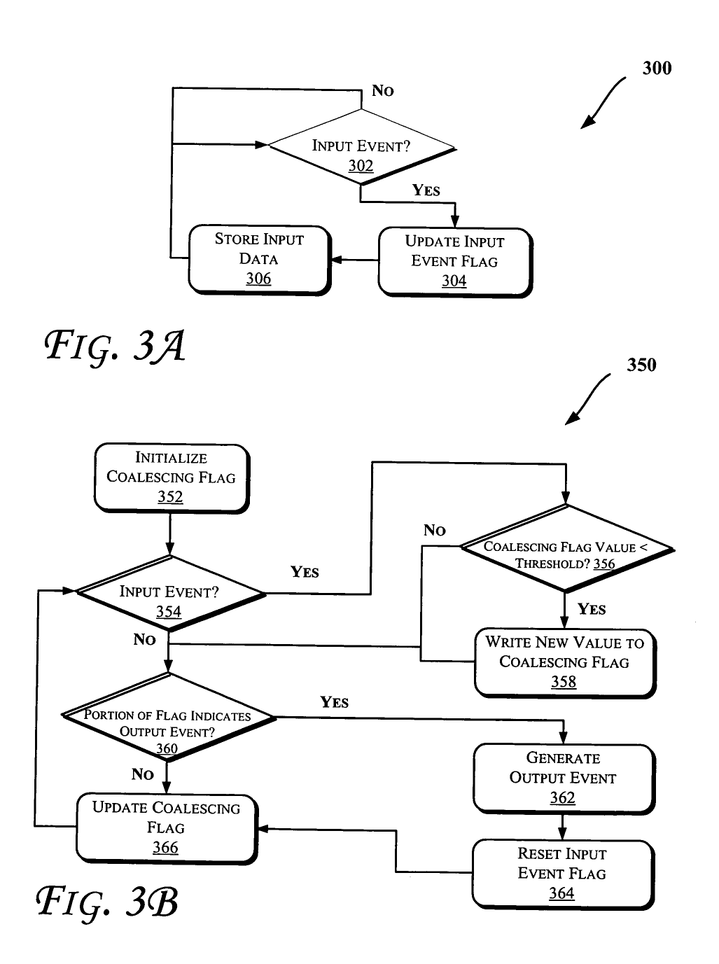

The system 100 may also include one or media interfaces 110 (e.g., in the network interface 105 in one embodiment) that are coupled to the network 108 to provide a physical interface for communication with the network 108. In one embodiment, the system 100 may include one media interface (110) for each of the processor cores 106, such as illustrated in the embodiment of FIG. 1. Also, the media interfaces 110 may be directly coupled to one or more components of the system 100 (see, e.g., the discussion of FIG. 2). As will be further discussed with reference to FIG. 3, the system 100 may be utilized to process data communicated over the network 108. For example, each of the processor cores 106 may execute one or more threads. One or more of these threads may generate an optional output event signal 112 such as an interrupt, e.g., to indicate to the processor(s) 102 that data received from the network 108 is awaiting processing. Alternatively, the threads executing on the processor cores 106 may provide an interrupt (or output event) communicated through the bus 104. Furthermore, the system 100 may include an input event flag 114 (e.g., within the network interface 105 in an embodiment) that is accessible by the processor cores 106 to indicate whether an input event has occurred, as will be further discussed with reference to FIGS. 3A and 3B. Also, at least one of the processor cores 106 may include a coalescing flag 116, as will be further discussed with reference to FIG. 3B. In various embodiments, each of the flags 114 and 116 may be stored in a hardware register.

As shown in FIG. 1, the system 100 may also include a memory controller 120 that is coupled to the bus 104. The memory controller 120 may be coupled to a memory 122 which may be shared by the processor(s) 102, the processor cores 106, and/or other components coupled to the bus 104. The memory 122 may store data and/or sequences of instructions that are executed by the processor(s) 102 and/or the processor cores 106, or other device included in the system 100. For example, the memory 122 may store data corresponding to one or more data packets communicated over the network 108 in one or more buffer(s) 124, as will be further discussed with reference to FIGS. 3A and 3B. The buffer(s) 124 may be first-in, first-out (FIFO) buffer(s) or queues. Also, the memory 122 may store code 126 including instructions that are executed by the processor(s) 102 and/or the processor cores 106.

In an embodiment, the memory 122 may include one or more volatile storage (or memory) devices such as those discussed with reference to FIG. 5. Moreover, the memory 122 may include nonvolatile memory (in addition to or instead of volatile memory) such as those discussed with reference to FIG. 5. Hence, the system 100 may include volatile and/or nonvolatile memory (or storage). Additionally, multiple storage devices (including volatile and/or nonvolatile memory) may be coupled to the bus 104.

FIG. 2 illustrates a block diagram of portions of a multiprocessor system 200, in accordance with an embodiment of the invention. The system 200 includes the processor(s) 102, bus 104, processor cores 106, memory controller 120, and memory 122 (including the buffer(s) 124 and code 126). As shown in FIG. 2, the system 200 may also include the media interface(s) 110 to communicate with the network 108. Since the media interface(s) 110 are directly coupled to the bus 104 in the system 200, various components of the system 200 (such as the processor(s) 102 and/or the processor cores 106) may communicate with the network 108 through the media interface(s) 110. Furthermore, the system 200 also includes the input event flag 114 and the coalescing flag 116, which may be provided at any suitable location in the system 200 that is accessible by one or more of the processor cores 106, as will be further discussed herein with reference to FIGS. 3A and 3B. As shown in FIG. 2, the input event flag 114 may be accessible through the bus 104 in one embodiment.

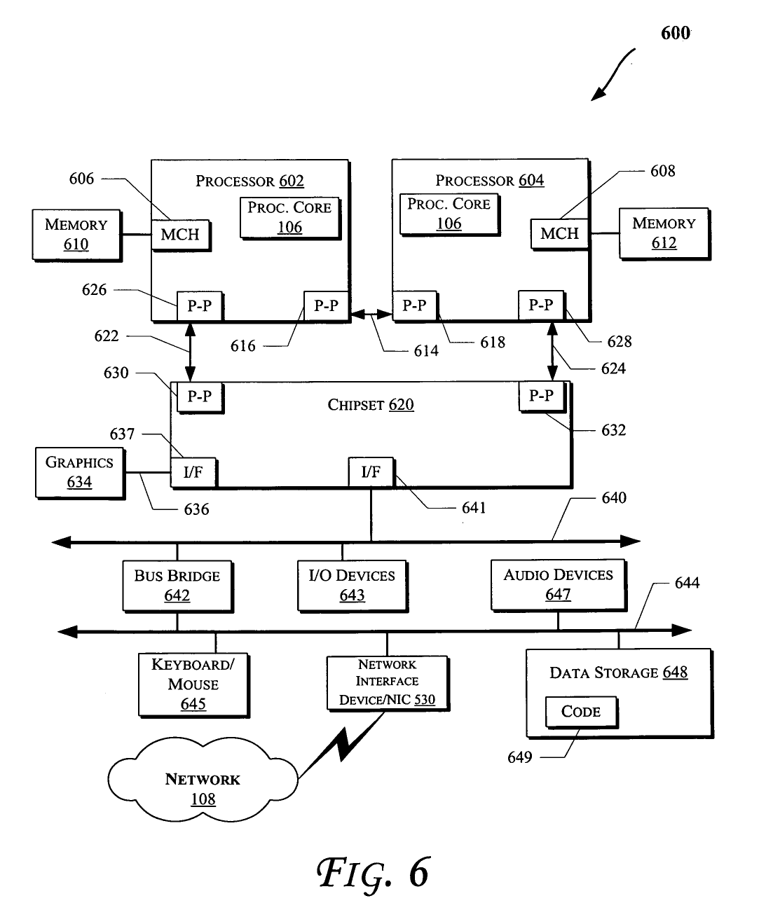

FIGS. 3A and 3B illustrate flow diagrams of embodiments of methods which may provide configurable notification generation. More particularly, FIG. 3A illustrates a flow diagram of an embodiment of a method 300 to update a flag (e.g., the input event flag 114 of FIGS. 1-2) to indicate whether an input event has occurred. FIG. 3B illustrates a flow diagram of an embodiment of a method 350 to generate an output event (e.g., an interrupt) to a processor, such as the processor(s) 102 of FIGS. 1-2, based on a portion of a configurable flag (e.g., the coalescing flag 116 of FIGS. 1-2). Various operations discussed with reference to the methods 300 and 350 may be performed by one or more threads executing on one or more components of the systems 100 and 200 of FIGS. 1 and 2, respectively. Various components of the systems 500 and 600 of the FIGS. 5 and 6 may also be utilized to perform the operations discussed with reference to the methods 300 and 350, as will be further discussed herein.

Referring to FIGS. 1, 2, and 3A, a thread executing on one of the processor cores 106 determines (302) when an input event occurs, e.g., when input data is received from the network 108 (for example, in the form of packets). The thread of the operation 302 updates (304) the input event flag 114 when the input event occurs. For example, if an input event occurs (302), the operation 304 may set the input event flag 114 (which may be a single status bit in an embodiment) to indicate that an input event has occurred. Alternatively, a clear input event flag 114 may be utilized to indicate that an input event has occurred. The thread of the operations 302 and 304 (or another thread such as the thread discussed with reference to FIG. 3B) may store (306) the input data in the buffer(s) 124. As shown in FIG. 3A, the method 300 continues to determine whether an input event has occurred (302) after the operation 306. Moreover, the operations 304 and 306 may be performed in any order, or simultaneously.

As discussed with reference to FIGS. 1 and 2, the input event flag 114 may be provided in any suitable location within the systems 100 and 200, such as shown in FIGS. 1 and 2, or as a variable stored in shared memory (e.g., in the memory 122). In an embodiment, the input event flag 114 may be a mutex (mutual exclusive) flag, e.g., to prevent the concurrent use of the input event flag 114 by different threads executing on the systems 100 or 200, such as the threads discussed with reference to FIGS. 3A and 3B.

Referring to FIGS. 1, 2, and 3B, operations discussed with reference to the method 350 may be performed by a single thread executing on one of the processor cores 106 which may or may not be the same processor core executing the thread discussed with reference to operations 302 and 304 of FIG. 3A. At an operation 352, the thread initializes the coalescing flag 116. The coalescing flag 116 may be stored in any suitable location in the systems 100 and 200, such as shown in FIGS. 1 and 2. In an embodiment, the coalescing flag 116 may be stored as a variable in shared memory (e.g., in the memory 122), rather than in at least one of the processor cores 106 such as discussed with reference to FIGS. 1 and 2. The thread determines (354) whether an input event has occurred (e.g., since a last check or polling operation), for example, by accessing the input event flag 114. If an input event has occurred (e.g., the input event flag 114 is set), the thread may determine (356) whether the value of the coalescing flag 116 is less than a threshold value (e.g., about “1”). If the thread determines that the value of the coalescing flag 116 is less than the threshold (e.g., “0”), the thread writes a new value to the coalescing flag 116 (358). Otherwise, the method 350 resumes with an operation 360 which determines whether a portion of the coalescing flag 116 (such as the least significant bit, or bit 0, of the coalescing flag 116) indicates that an output event is to be generated. For example, a “0”may indicate that no output event is to be generated and a “1” may indicate that an output event is to be generated (or vice versa).

If the thread determines that an output event is to be generated, the thread generates an output event (362) and resets the input event flag 114 (364), e.g., to indicate that an output event has been generated for the stored input data (such as discussed with reference to the operation 306 of FIG. 3A). The operations 362 and 364 may be performed in any order, or simultaneously. Furthermore, since the threads corresponding to the operations 302-304 of FIG. 3A may be executing simultaneously as the thread corresponding to the operations of the method 350, the input event flag 114 may be locked during the operations 354 through 364 to provide mutual exclusivity in an embodiment. The output event generated by the operation 362 may be an interrupt to the processor(s) 102, for example, provided through the output event signal(s) 112 or the bus 104. Once the processor(s) 102 receives the generated output event, the processor(s) may access the buffer(s) 124 to retrieve the data stored (e.g., by the operation 306 of FIG. 3A) for processing.

After the operation 360 determines that no output event is to be generated or the operation 364 resets the input event flag 114, the method 350 resumes with an operation 366 which updates the coalescing flag 116. For example, the coalescing flag 116 may be shifted right (or left depending on the implementation) by one bit. After the operation 366, the method 350 resumes at the operation 354. In an embodiment, the method 350 provides improved data throughput and/or decreased latency (with decreased processor resource usage), when compared with purely event-driven or polling and queuing mechanisms.

In one embodiment, the value written to the coalescing flag 116 (at the operations 352 and/or 358) may be “0×81” (or “10000001” in binary). Such a value may generate an output event (or interrupt) (362) on reception of a packet, with no further output events occurring (e.g., coalescing) until the thread corresponding to the operations of the method 350 has shifted the coalescing flag (116) 7 times. In embodiments that initialize the coalescing flag 116 to a value that has a “1” in the most significant bit, the operation 356 may determine whether the coalescing flag value is less than or equal to the threshold value (rather than less than), for example, to avoid generation of back to back output events at operation 362. In one embodiment, the thread corresponding to the operations 302 and 304 of FIG. 3A may have a higher priority than the thread corresponding to the operations of FIG. 3B, e.g., to decrease processor resource usage during high traffic periods.

In an embodiment, the methods 300 of FIG. 3A and 350 of FIG. 3B may provide an efficient mechanism to handle small bursts of network activity such as a TCP (transmission control protocol) based traffic pattern. At relatively low traffic rates and depending on the configured value of the coalescing flag 116, multiple output events may be generated back to back. At relatively high traffic rates, the configurable value stored in the coalescing flag 116 may offer the possibility of an irregular output event generation rate. This may break the hysteretic effects which may be present in some applications at some traffic rates. For example, the use of the binary pattern 10010000001 would trigger an output event every 7 packets, then every 3 packets. Also, a pool of different values may be utilized to write to the coalescing flag (e.g., at the operations 358 and/or 352 of FIG. 3B).

Moreover, different schemes may be utilized depending on the implementation. The value to reload (e.g., at operation 358) may be always 1 when the application running on the processor 102 has enough spare processing resources. The configured value (116) may be changed to a higher power of 2 (e.g., binary value 10000000). This would delay the first output event and may be an efficient feedback mechanism, e.g., when a packet including voice data is received and processing resources need to be spared, e.g., for the requirements of a DSP (digital signal processing) algorithm. A timer may restore this value to a lower power of 2 shortly before the next packet including voice data is expected.

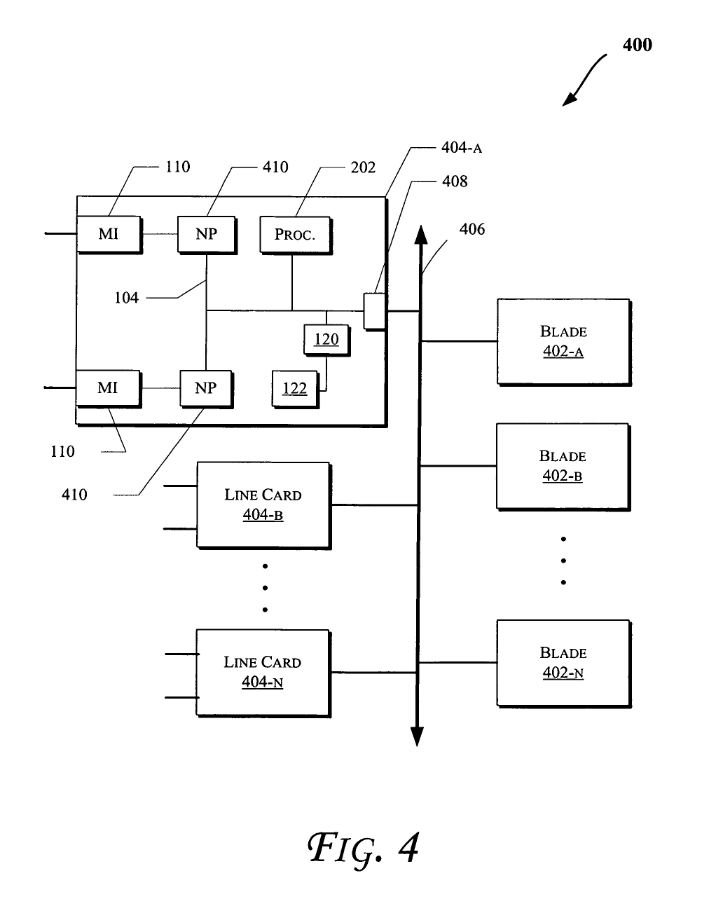

The systems 100 and 200 of FIGS. 1 and 2, respectively, may be used in a variety of applications. In networking applications, for example, it is possible to closely couple packet processing and general purpose processing for optimal, high-throughput communication between packet processing elements of a network processor (e.g., a processor that processes data communicated over a network, for example, in form of data packets) and the control and/or content processing elements. For example, as shown in FIG. 4, an embodiment of a distributed processing platform 400 may include a collection of blades 402-A through 402-N and line cards 404-A through 404-N interconnected by a backplane 406, e.g., a switch fabric. The switch fabric, for example, may conform to common switch interface (CSIX) or other fabric technologies such as advanced switching interconnect (ASI), HyperTransport, Infiniband, peripheral component interconnect (PCI), Ethernet, Packet-Over-SONET (synchronous optical network), RapidIO, and/or Universal Test and Operations PHY (physical) Interface for asynchronous transfer mode (ATM) (UTOPIA).

In one embodiment, the line cards (404) may provide line termination and input/output (I/O) processing. The line cards (404) may include processing in the data plane (packet processing) as well as control plane processing to handle the management of policies for execution in the data plane. The blades 402-A through 402-N may include: control blades to handle control plane functions not distributed to line cards; control blades to perform system management functions such as driver enumeration, route table management, global table management, network address translation, and messaging to a control blade; applications and service blades; and/or content processing blades. The switch fabric or fabrics (406) may also reside on one or more blades. In a network infrastructure, content processing may be used to handle intensive content-based processing outside the capabilities of the standard line card functionality including voice processing, encryption offload and intrusion-detection where performance demands are high.

At least one of the line cards 404, e.g., line card 404-A, is a specialized line card that is implemented based on the architecture of systems 100 and/or 200, to tightly couple the processing intelligence of a processor to the more specialized capabilities of a network processor (e.g., a processor that processes data communicated over a network). The line card 404-A includes media interfaces 110 to handle communications over network connections (e.g., the network 108 discussed with reference to FIGS. 1 and 2). Each media interface 110 is connected to a processor, shown here as network processor (NP) 410 (which may be the processor cores 106 in an embodiment). In this implementation, one NP is used as an ingress processor and the other NP is used as an egress processor, although a single NP may also be used. Also, one NP may be used to execute the thread discussed with reference to operations 302-304 of FIG. 3A and the other NP may be used to execute the thread discussed with reference to operations of FIG. 3B. Other components and interconnections in system 400 are as shown in FIGS. 1 and 2. Here, the bus 104 may be coupled to the switch fabric 406 through an input/output (I/O) block 408. In an embodiment, the bus 104 may be coupled to the I/O block 408 through the memory controller 120. Alternatively, or in addition, other applications based on the multiprocessor systems 100 and 200 could be employed by the distributed processing platform 400. For example, for optimized storage processing, such as applications involving an enterprise server, networked storage, offload and storage subsystems applications, the processor 410 may be implemented as an I/O processor. For still other applications, the processor 410 may be a co-processor (used as an accelerator, as an example) or a stand-alone control plane processor. Depending on the configuration of blades 402 and line cards 404, the distributed processing platform 400 may implement a switching device (e.g., switch or router), a server, a voice gateway or other type of equipment.

FIG. 5 illustrates a block diagram of a computing system 500 in accordance with an embodiment of the invention. The computing system 500 may include one or more central processing unit(s) (CPUs) 502 or processors coupled to an interconnection network (or bus) 504. The processors (502) may be any suitable processor such as a network processor (that processes data communicated over a computer network 108) or the like (including a reduced instruction set computer (RISC) processor or a complex instruction set computer (CISC)). Moreover, the processors (502) may have a single or multiple core design. The processors (502) with a multiple core design may integrate different types of processor cores on the same integrated circuit (IC) die. Also, the processors (502) with a multiple core design may be implemented as symmetrical or asymmetrical multiprocessors. Furthermore, the processor(s) 502 may optionally include one or more of the processor cores 106 and/or the processor 102. Additionally, the operations discussed with reference to FIGS. 1-4 may be performed by one or more components of the system 500.

A chipset 506 may also be coupled to the interconnection network 504. The chipset 506 may include a memory control hub (MCH) 508. The MCH 508 may include a memory controller 510 that is coupled to a memory 512. The memory 512 may store data and sequences of instructions that are executed by the processor(s) 502, or any other device included in the computing system 500. For example, the memory 512 may store the buffer(s) 124 and/or the code 126 discussed with reference to FIGS. 1-2. In one embodiment of the invention, the memory 512 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may be coupled to the interconnection network 504, such as multiple CPUs and/or multiple system memories.

The MCH 508 may also include a graphics interface 514 coupled to a graphics accelerator 516. In one embodiment of the invention, the graphics interface 514 may be coupled to the graphics accelerator 516 via an accelerated graphics port (AGP). In an embodiment of the invention, a display (such as a flat panel display) may be coupled to the graphics interface 514 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 518 may couple the MCH 508 to an input/output control hub (ICH) 520. The ICH 520 may provide an interface to I/O devices coupled to the computing system 500. The ICH 520 may be coupled to a bus 522 through a peripheral bridge (or controller) 524, such as a peripheral component interconnect (PCI) bridge, a universal serial bus (USB) controller, or the like. The bridge 524 may provide a data path between the CPU 502 and peripheral devices. Other types of topologies may be utilized. Also, multiple buses may be coupled to the ICH 520, e.g., through multiple bridges or controllers. Moreover, other peripherals coupled to the ICH 520 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 522 may be coupled to an audio device 526, one or more disk drive(s) 528, and a network interface device 530 (which is coupled to the computer network 108). In one embodiment, the network interface device 530 may be a network interface card (NIC). As shown in FIG. 5, the network interface device 530 may include a physical layer (PHY) 532 (e.g., to physically interface the network interface device 530 with the network 108), a media access control (MAC) 534 (e.g., to provide an interface between the PHY 532 and a portion of a data link layer of the network 108, such as a logical link control), the input event flag 114, and/or the coalescing flag 116. As discussed with reference to FIGS. 1-3B, the input event flag 114 and/or the coalescing flag 116 may be located in any suitable location within the system 500 (for example, stored as a variable in shared memory (e.g., in the memory 512). Also, in various embodiments, each of the flags 114 and 116 may be stored in a hardware register. Furthermore, the network interface device 530 may optionally include an output event generation logic 536 (instead of or in addition to the processor cores 106 that may be optionally provided in the processor(s) 502), for example, to perform one or more of the operations discussed with reference to methods 300 and 350 of FIGS. 3A and 3B, respectively. For example, the output event generation logic 536 may generate an output event (e.g., an interrupt) to the processor(s) 502 at the operation 362 of FIG. 3B. Alternatively, software executing on the processor(s) 502 (alone or in conjunction with the output event generation logic 536) may perform one or more of the operations discussed with reference to methods 300 and 350 of FIGS. 3A and 3B, respectively. In one embodiment, the network interface device 530 may include the network interface 105 of FIG. 1. Other devices may be coupled to the bus 522. Also, various components (such as the network interface device 530) may be coupled to the MCH 508 in some embodiments of the invention. In addition, the processor 502 and the MCH 508 may be combined to form a single chip. Furthermore, the graphics accelerator 516 may be included within the MCH 508 in other embodiments of the invention.

Additionally, the computing system 500 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 528), a floppy disk, a compact disk ROM (CD-ROM), a digital versatile disk (DVD), flash memory, a magneto-optical disk, or other types of nonvolatile machine-readable media suitable for storing electronic instructions and/or data.

FIG. 6 illustrates a computing system 600 that is arranged in a point-to-point (PtP) configuration, according to an embodiment of the invention. In particular, FIG. 6 shows a system where processors, memory, and input/output devices are interconnected by a number of point-to-point interfaces. The operations discussed with reference to FIGS. 1-4 may be performed by one or more components of the system 600.

As illustrated in FIG. 6, the system 600 may include several processors, of which only two, processors 602 and 604 are shown for clarity. Optionally, the processors 602 and 604 may include the processor cores 106 and/or the processor 102 of FIGS. 1-2. The processors 602 and 604 may each include a local memory controller hub (MCH) 606 and 608 to couple with memories 610 and 612. The memories 610 and/or 612 may store various data such as those discussed with reference to the memories 122 and/or 512. For example, the memories 610 and/or 612 may store the buffer(s) 124 and/or the code 126 discussed with reference to FIGS. 1-2.

The processors 602 and 604 may be any suitable processor such as those discussed with reference to the processors 502 of FIG. 5. The processors 602 and 604 may exchange data via a point-to-point (PtP) interface 614 using PtP interface circuits 616 and 618, respectively. The processors 602 and 604 may each exchange data with a chipset 620 via individual PtP interfaces 622 and 624 using point to point interface circuits 626, 628, 630, and 632. The chipset 620 may also exchange data with a high-performance graphics circuit 634 via a high-performance graphics interface 636, using a PtP interface circuit 637.

At least one embodiment of the invention may be provided by utilizing the processors 602 and 604. For example, the processor cores 106 that execute the threads discussed with reference to FIGS. 3A and 3B may be located within the processors 602 and 604. Other embodiments of the invention, however, may exist in other circuits, logic units, or devices within the system 600 of FIG. 6. Furthermore, other embodiments of the invention may be distributed throughout several circuits, logic units, or devices illustrated in FIG. 6.

The chipset 620 may be coupled to a bus 640 using a PtP interface circuit 641. The bus 640 may have one or more devices coupled to it, such as a bus bridge 642 and I/O devices 643. Via a bus 644, the bus bridge 643 may be coupled to other devices such as a keyboard/mouse 645, the network interface device 530 discussed with reference to FIG. 5 (such as modems, network interface cards (NICs), or the like that may be coupled to the computer network 108), audio I/O device, and/or a data storage device 648. The data storage device 648 may store code 649 that may be executed by the processors 602 and/or 604.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any suitable storage device such as those discussed with respect to FIGS. 1, 5, and 6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
one or more processor cores to:
execute a first thread to update an input event flag when an input event occurs;
execute a second thread to:
write a coalescing value to a coalescing flag if:
the input event flag indicates that the input event has occurred; and
the coalescing flag has a value that is less than a threshold value; and
generate an output event if a portion of the coalescing flag indicates that the output event is to be generated; and
update the coalescing flag.

2. The apparatus of claim 1, wherein the portion of the coalescing flag comprises a least significant bit of the coalescing flag.

3. The apparatus of claim 1, wherein the threshold value is about 1.

4. The apparatus of claim 1, further comprising a memory to store input data received from a computer network according to the input event.

5. The apparatus of claim 1, further comprising a processor to process input data received according to the input event in response to the generated output event.

6. The apparatus of claim 1, further comprising a memory to store input data received according to the input event, wherein one of the first or second threads stores the input data in the memory.

7. The apparatus of claim 1, further comprising a first-in, first-out buffer to store input data received according to the input event.

8. The apparatus of claim 1, further comprising one or more hardware registers to each store one or more of the input event flag or the coalescing flag.

9. The apparatus of claim 1, wherein the one or more processor cores are on a same integrated circuit die.

10. The, apparatus of claim 1, wherein the one or more processor cores are processor cores of a symmetrical multiprocessor or an asymmetrical multiprocessor.

11. A method comprising:
updating an input event flag when an input event occurs;
writing a coalescing value to a coalescing flag if:
the input event flag indicates that the input event has occurred; and
the coalescing flag has a value that is less than a threshold value; and
generating an output event if a portion of the coalescing flag indicates that the output event is to be generated; and
updating the coalescing flag.

12. The method of claim 11, wherein updating the coalescing flag comprises shifting the coalescing flag by one bit to right or left.

13. The method of claim 11, wherein generating the output event comprises generating an interrupt to a processor to process input data received from a computer network according to the input event.

14. The method of claim 11, further comprising resetting the input event flag if the portion of the coalescing flag indicates that the output event is to be generated.

15. The method of claim 11, further comprising:
writing the coalescing value to the coalescing flag if:
the input event flag indicates that the input event has occurred; and
the coalescing flag has a value that is equal to the threshold value.

16. The method of claim 11, further comprising storing input data received from a computer network in a first-in, first-out buffer and processing the stored input data after the output event is generated.

17. A computer-readable medium comprising instructions that when executed on a processor configure the processor to perform operations comprising:
updating an input event flag when an input event occurs;
writing a coalescing value to a coalescing flag if:
the input event flag indicates that the input event has occurred; and
the coalescing flag has a value that is less than a threshold value; and
generating an output event if a portion of the coalescing flag indicates that the output event is to be generated; and
updating the coalescing flag.

18. The computer-readable medium of claim 17, wherein the operations further comprise storing input data received from a computer network in a first-in, first-out buffer and processing the stored input data after the output event is generated.

19. The computer-readable medium of claim 17, wherein updating the coalescing flag comprises shifting the coalescing flag by one bit to right or left.

20. A traffic management device comprising:
a switch fabric; and
an apparatus to process data communicated via the switch fabric comprising:
one or more processor cores to:
execute a first thread to update an input event flag when an input event occurs;
execute a second thread to:
write a coalescing value to a coalescing flag if:
the input event flag indicates that the input event has occurred; and
the coalescing flag has a value that is less than a threshold value; and
generate an output event if a portion of the coalescing flag indicates that the output event is to be generated; and
update the coalescing flag.

21. The traffic management device of claim 20, wherein the switch fabric conforms to one or more of common switch interface (CSIX), advanced switching interconnect (ASI), HyperTransport, Infiniband, peripheral component interconnect (PCI), Ethernet, Packet-Over-SONET (synchronous optical network), or Universal Test and Operations PHY (physical) Interface for ATM (UTOPIA).

22. The traffic management device of claim 20, further comprising a processor to process input data received from a computer network in response to the generated output event.

23. A network interface card comprising:
a media access control; and
output event generation logic to:
update an input event flag when an input event occurs;
write a coalescing value to a coalescing flag if:
the input event flag indicates that the input event has occurred; and
the coalescing flag has a value that is less than a threshold value; and
generate an output event if a portion of the coalescing flag indicates that the output event is to be generated; and
update the coalescing flag.

24. The network interface card of claim 23, further comprising a processor to process input data received according to the input event in response to the generated output event.

25. The network interface card of claim 23, wherein the output event generation logic writes the coalescing value to the coalescing flag if:
the input event flag indicates that the input event has occurred; and
the coalescing flag has a value that is equal to the threshold value.
